(19) United States
(12) Patent Application Publication
(10) Pub. No.: US 2009/0067172 A1
(43) Pub. Date: Mar. 12, 2009

(54) LIGHTING APPARATUS

(76) Inventors: MASARU INOUE, Kanagawa-ken (JP); KEIICHI SHIMIZU, Kanagawa-ken (JP); SUMIO HASHIMOTO, Kanagawa-ken (JP); HIROKAZU OTAKE, Kanagawa-ken (JP); MITSUHIKO NISHIIE, Shizuoka-ken (JP); TAKURO HIRAMATSU, Kanagawa-ken (JP); MASATOSHI KUMAGAI, Kanagawa-ken (JP)

Correspondence Address: DLA PIPER LLP US, P. O. BOX 2758, RESTON, VA, 20195, US

(21) Appl. No.: 12/205,460

(22) Filed: Sep. 5, 2008

(30) Foreign Application Priority Data
Sep. 5, 2007 (JP) 2007-230701

(51) Int. Cl. F21V 7/04

(52) U.S. Cl. 362/240; 362/346

(57) ABSTRACT

A lighting apparatus comprises a housing, a light source comprising a plurality of semiconductor light emitting devices, and allocated in the housing so as that the semiconductor light emitting devices are directed downward, a first reflector, which is mounted beneath the light source and formed in a convex body gradually thinning down toward upward, comprising a plurality of segmental reflectors having on its top a installation hole for arranging the semiconductor light emitting device and on its bottom opened wider than the installation hole, and a second reflector allocated beneath the first reflector, wherein the height of the second reflector is defined to secure that a first light shielding angle specified by a straight line passing through the semiconductor light emitting device and the bottom edge of the segmental reflector of the first reflector is larger than a second light shielding angle specified by a straight line passing through the bottom edge of the segmental reflector of the first reflector and the bottom edge of the second reflector.

### CROSS REFERENCE TO RELATED APPLICATIONS

This application is based upon and claims the benefit of priority from the prior Japanese Application No. 2007-230701, filed on Sep. 5, 2007, the entire contents of which are incorporated herein by reference.

### FIELD OF THE INVENTION

The present invention relates to a lighting apparatus such as ceiling recess installation type down-light, which utilizes a semiconductor light emitting device such as an LED (light emitting diode) as a light source.

### BACKGROUND OF THE INVENTION

As one example of such a down-light, there is known a down-light, wherein a light source block, a lighting circuit block, a mounting board and a terminal block are comprised in a housing and wherein a frame is mounted to a bottom opening for emitting light outside is (see, e.g., Japanese laid-open patent application JP2006-172895A, paragraphs 0020-0030, FIGS. 1-7).

In such a type of down-light, a mounting board is provided horizontally in the housing. A lighting circuit block and a terminal block are mounted on the upper surface of the mounting board. Further a light source block is mounted on the lower surface of the mounting board. The light source block comprises a printed circuit board mounting thereon a plurality of LED, and a lens system for controlling spatial distribution of luminous intensity of light emitted from the LED. The lens system is formed in a thin cylindrical shape by light-transmissive material. The lens system is provided with a space for accommodating a printed circuit board on which a depression for arranging each LED is formed on its upper side. The frame comprises a cylindrical side wall whose diameter gradually expanding as progressed from top to bottom and a flange provided at the bottom portion of the frame. The flange is so formed to hang over a brim portion of the housing and catch on a lip of the ceiling recess. The inner surface of the side wall serves as a reflective surface for guiding downward light transmitting through the lens system from the light source block and introduced into the cylindrical side wall.

In the down-light, disclosed in the prior art JP2006-172895A, the light emerging surface of the lens system which controls luminous intensity distribution of the light emitted from the LED is horizontally disposed at the level closing the upper opening of the frame. Thereby, during the downright lighting, the whole region shines brightly. As a result, the light source block itself fails to achieve a desirable light shielding angle.

In order to counteract the disadvantage in the down-light, disclosed in the prior art JP2006-172895A, the lens system may be directly allocated beneath the housing by removing the frame which unwillingly reflects the light from the light source block. However, there occurs in such a modification another problem that since the luminosity of the LED itself is extremely high, a dazzle feeling of a light source block becomes strongly conspicuous. While in a down-light, wherein the frame is allocated beneath the light source block like the down-light, disclosed in the prior art JP2006-172895A, a certain degree of light shielding angle can be ensured by a frame. However, for enlarging the light shielding angle further, the height of the frame must be increased. Here, on the other hand, when the height of the frame is increased, there occurs still another problem that the downright illumination zone obtained by reflection on the frame becomes narrower.

Further, the lens system provided in the down-light, disclosed in the prior art JP2006-172895A for controlling the luminous intensity distribution is formed to have a total-internal-reflection surface for effectively utilizing the light illuminated from the LED. A lens system having such a total-internal-reflection surface must have above a certain degree of thickness. Thereby, in manufacturing of the lens system, a molding tact time becomes long. As a result, the manufacture efficiency is insufficient and thus the manufacturing of the lens system is costly.

### SUMMARY OF THE INVENTION

It is an object of the present invention to provide a lighting apparatus capable of deadening glare by ensuring expected light shielding angle with luminous intensity distribution control member that controls the luminous intensity distribution of the light emitted from a semiconductor light emitting device and able to lower costs of the lighting apparatus.

In order to achieve the object, the lighting apparatus according to a first aspect of the present invention is comprised of a housing, a light source comprising a plurality of semiconductor light emitting devices, and allocated in the housing so as that the semiconductor light emitting devices are directed downward, a first reflector, which is mounted beneath the light source and formed in a convex body gradually thinning down toward upward, comprising a plurality of segmental reflectors having on its top a installation hole for arranging the semiconductor light emitting device and on its bottom opened wider than the installation hole, and a second reflector allocated beneath the first reflector, wherein the height of the second reflector is defined to secure that a first light shielding angle specified by a straight line passing through the semiconductor light emitting device and the bottom edge of the segmental reflector of the first reflector is larger than a second light shielding angle specified by a straight line passing through the bottom edge of the segmental reflector of the first reflector and the bottom edge of the second reflector.

In order to achieve the object, the lighting apparatus according to a second aspect of the present invention is comprised of a housing, a light source comprising a plurality of semiconductor light emitting devices, and allocated in the housing so as that the semiconductor light emitting devices are directed downward, and a first reflector, which is mounted beneath the light source and formed in a convex body gradually thinning down toward upward, comprising a plurality of segmental reflectors having on its top a installation hole for arranging the semiconductor light emitting device and on its bottom opened wider than the installation hole, wherein adjacent segmental reflectors form a downward crest beneath the installation hole, and the installation hole is allocated between adjacent crests at an obliquely upward recess from the crest.

The lighting apparatus according to the first and the second aspects of the present invention are utilized by recessing in ceiling recess. As the semiconductor light emitting device for the light source, LEDs, organic EL devices (organic electro-luminescence device), etc. can be employed. A perfect diffuse reflection function is established, or these very thing is molded into the inner surface of the base made of metal or resin with white resin, and, as for the first reflector and second reflector, the inner surface can have complete diffuser reflex action in it. Especially, in the second aspect of the lighting apparatus the downward crest between each segmental reflector is continuing mutually. The shape made by these crests takes a configuration complying with the bottom geometry of the first reflector. For example, when the bottom geometry of the first reflector is annular, the crest radially extended from the central part is formed. When the bottom geometry of the first reflector is square, a curb-lattice shape crest is formed.

Particularly, in the lighting apparatus according to the second aspect of the invention, a plurality of segmental reflectors form a downward crest, and adjoin mutually with the lighting apparatus of the second form especially has referred to that between adjoining segmental reflectors is continuing via a crest. In the case, the segmental reflector may be a configuration which shares the crest, or the independent segmental reflector may be a configuration in which they tightly adjoin each other at their crests or adjoin each other leaving a small gap.

In the lighting apparatus according to the second aspect of the invention, since the luminous intensity distribution of the light emitted from the semiconductor light emitting device is controlled by the first reflector necessary for controlling the luminous intensity distribution is easy to manufacture, as compared with a manufacturing of a total-reflective lens. Manufacture is easier when molding the first reflector by white resin especially. Therefore, upon reduction of the manufacturing cost of the first reflector, the cost cut of a lighting apparatus is possible.

Further to the lighting apparatus according to the second aspect of the present invention, a lighting apparatus according to a third aspect of the present invention comprises, a second reflector having openings at its top and bottom, wherein the second reflector is allocated beneath the first reflector so as that the open top of the second reflector is connected to the bottom edge of first reflector, and wherein the height of the second reflector is defined to secure that a first light shielding angle specified by a straight line passing through—the semiconductor light emitting device and the crest of the segmental reflector of the first reflector is larger than a second light shielding angle specified by a straight line passing through the bottom edge of the segmental reflector of the first reflector and the bottom edge of the second reflector.

Further to the lighting apparatus according to the third aspect of the invention, the lighting apparatus according to the fourth aspect of the invention is characterized by allocating the light-transmissive insulation cover which covers the light reflector from a lower part so that an above top end opening may be closed at the upper end of the second reflector of the above while it makes the upper end opening of the second reflector of the above smaller than a bottom opening.

### BRIEF DESCRIPTION OF THE DRAWINGS

FIG. 1 is a partial section showing a down-light, according to one embodiment of the present invention;

FIG. 2 is a partial cut-away perspective view of the down-light, of FIG. 1, which is seen from obliquely downward;

FIG. 3 is a bottom view showing the down-light, of FIG. 1; and

FIG. 4 is a perspective view showing a second reflector equipped in the down-light, of FIG. 1.

### DESCRIPTION OF THE PREFERRED EMBODIMENTS

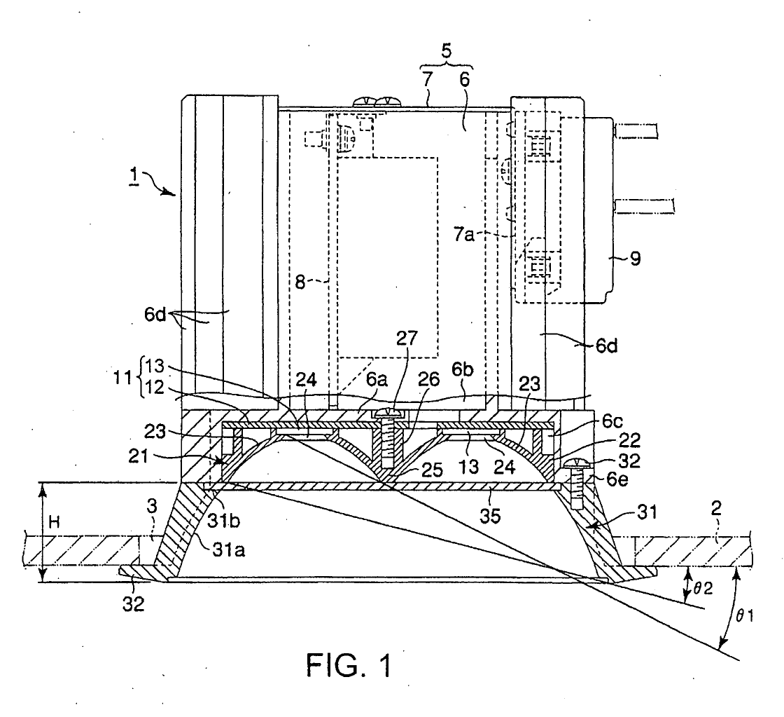

Referring now to the mounted drawings, FIGS. 1 to 4, one embodiments of the present invention will be explained hereinafter.

In FIG. 1 to FIG. 3, the reference numeral 1 denotes a lighting apparatus, for example, a down-light. A down-light 1 is installed in a recess, for example on an indoor ceiling 2 as shown in FIG. 1. In FIG. 1, the reference numeral 3 denotes the ceiling recess of the ceiling 2. The ceiling recess 3 is an opening left behind that an old down-light, has been removed, or an opening newly bored in the ceiling 2.

The down-light 1 is provided with a housing 5, a light source 11, an electric power unit 8, a terminal block 9, a first reflector 21, a second reflector 31, a transparent cover plate 35, and a pair of mounting springs 41.

As shown in FIG. 1, the housing 5 is preferably made of metal in order to make easy heat dissipation of the heat emitted from an LED which will be mentioned later. A housing principal member 6 of the housing 5 is screwed to the housing principal member 6. The housing principal member 6 has a power supply unit storage space 6b on the upper side of the annular bottom wall 6a. The housing principal member 6 has further a light source mount block 6c beneath the bottom wall 6a, and a plurality of heat radiation fins 6d on the perimeter of the bottom wall 6a. The light source mount block 6c is configured in a short cylindrical shape opening its bottom end. The fastening portion 6e is formed in the outside plurality place of the bottom opening edge of the light source mount block 6c. The upper end opening of the power supply unit storage space 6b is closed by the top plate 7.

The electric power unit 8 and the terminal block 9 are mounted to the housing 5. The electric power unit 8 is accommodated in the power supply unit storage space 6b, and the terminal block 9 is mounted to the part 7a bent over the side of the housing principal member 6 of the top plate 7. The electric power unit 8 has a function which controls the lighting current of LED which will be mentioned later, and the terminal block 9 supplies a commercial AC power to the electric power unit 8.

As shown in FIG. 1, the light source 11 and the first reflector 21 are accommodated in the light source mount block 6c. The light source 11 is provided with a plurality of semiconductor light emitting devices, for example, LEDs 13. The semiconductor light emitting devices are mounted on the surface of the light source support board 12.

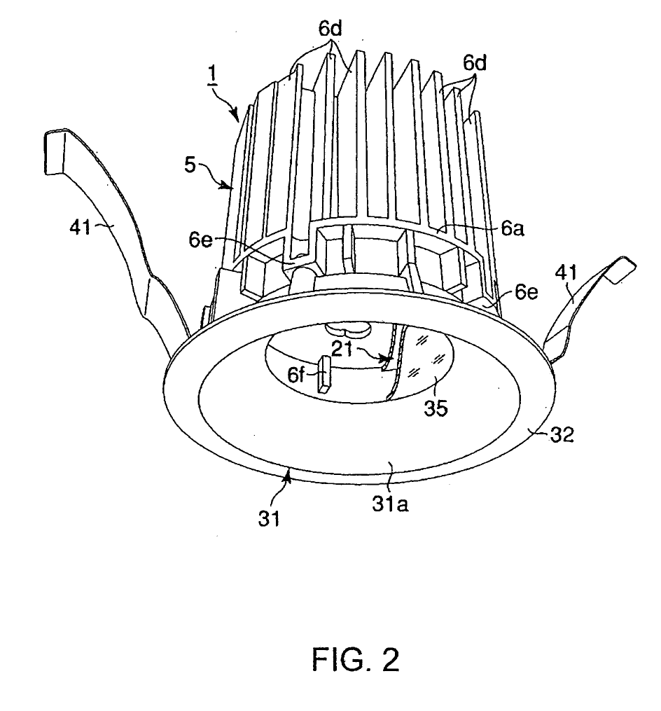

The light source support board 12 has an annular shape, and the back of the light source support board 12 where the LEDs 13 is allocated in the light source mount block 6c by tightly contacting to the under side of the bottom wall 6a. Reference numeral 6f in FIG. 2 denotes a positioning convex, for example, a rib. A plurality of the positioning convexes or the ribs are provided on the inner surface of the light source mount block 6c. Here, in FIG. 2, only one rib 6f is typically illustrated for simplicity of explanation. When a surface-corrugated periphery of the light source support board 12 engages with the rib 6f, the light source 11 is positioned to the light source mount block 6c.

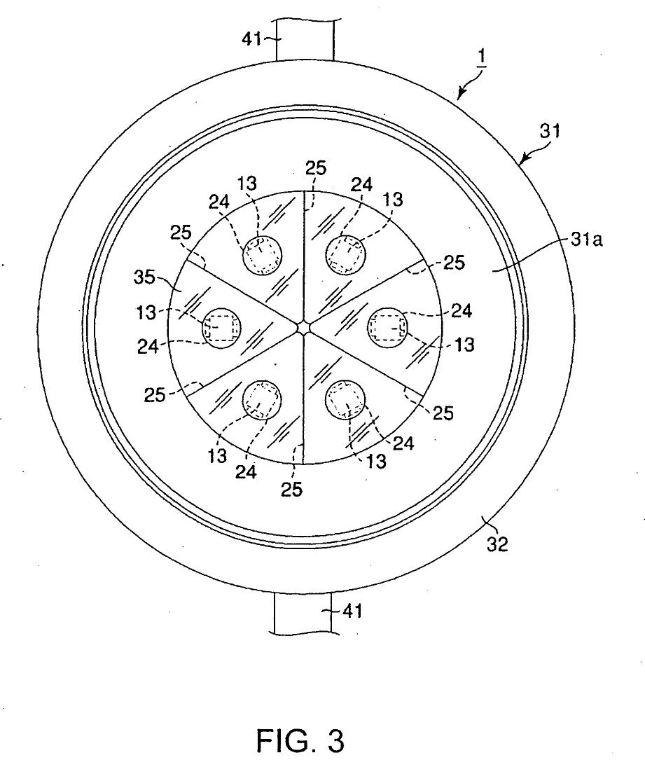

The light source 11 has six pieces of LEDs 13, as shown, for example in FIG. 3. These six pieces of LEDs 13 are annularly allocated at intervals of the constant interval, i.e., 60 degrees, on the light source support board 12. The LED 13 is provided with an LED chip which illuminates blue light, a reflector enclosing the LED chip and light-transmissive sealing resin containing fluorescent substance which is filled in the reflector for sealing the LED chip. As for the fluorescent substance mixed in the sealing resin, fluorescent substance which is excited by the blue light emitted from the LED chip and primarily emits yellow light complimentary to the blue light is employed. Therefore, each LED 13 emits a white light.

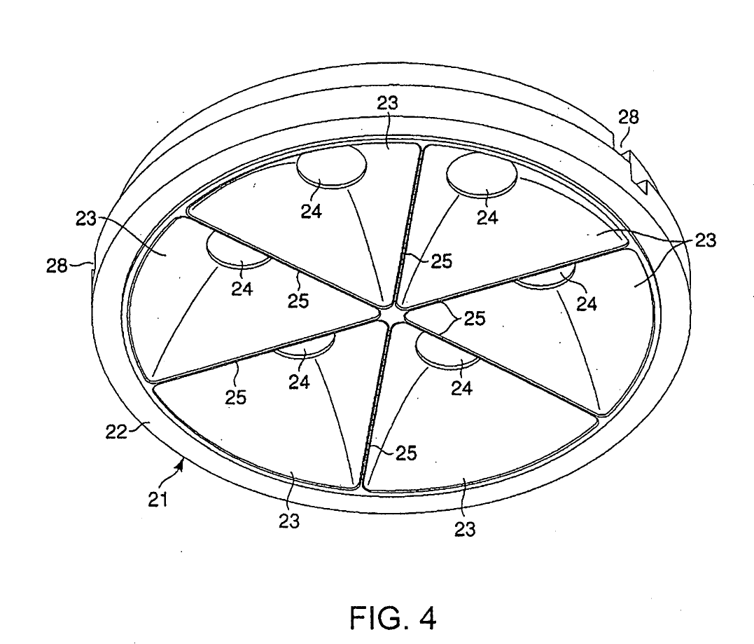

The first reflector 21 is a cast of a white synthetic resin, and functions as first luminous intensity distribution controlling member that controls controlling the luminous intensity distribution of the light emitted from the LED 13. The first reflector 21 is allocated in the light source mount block 6c at the light source 11 bottom. The first reflector 21 has the segmental reflector 23 of LED 13 and the same number on a plurality of segmental reflectors and the concrete target in which the opening of the undersurface is carried out inside the frame 22 as shown in FIG. 1 and FIG. 4. The first reflector 21 is formed corresponding to the shape of the light source support board 12. According to the above embodiment, the frame 22 of the first reflector 21 is making ring shape.

Each segmental reflector 23, which serves as an upward convex, has the hole 24 in the top of the convex, and carries out the bottom opening, and is formed. The bottom opening of the segmental reflector 23 is larger than the hole 24. The downward crest 25 is formed between each segmental reflector 23 adjoined along the direction of a circumference of the frame 22, and between these-adjoined segmental reflector 23 the downward crest is formed. Each crest 25 is making the shape of a point thin next door section abbreviation V character as represented and shown in FIG. 1 and it goes below.

Since it has extended radial from the central part of the first reflector 21 and the above-mentioned central part and the frame 22 are covered, each crest 25 is formed so that the down-light 1 may be seen from a lower part and the segmental reflector 23 may be divided every 60 degrees. While these crests 25 are formed below the hole 24, the hole 24 is allocated between the crests 25 which adjoined, respectively. The side wall running from the inner periphery of each crest 25 and the frame 22 to the hole 24 is formed by the reflecting barriers in which the section makes an arc.

The first reflector 21 has the screw reception threaded boss 26 who protrudes upward at the back. In the case of the above embodiment, the screw reception threaded boss 26 is formed in the central part back of the first reflector 21. The first reflector 21 is being fixed to the light source mount block 6c with the fastening screw 27 against which it protested to the screw reception threaded boss 26 from the upper part through the central part of the bottom wall 6aa and the light source support board 12, and LED 13 is allocated at each of that hole 24, respectively. With the fixation, the upper end of the frame 22 of the first reflector 21 sandwiches the periphery of the light source support board 12 between the bottom walls 6a, and thereby, the back of the light source support board 12 is close to the undersurface of the bottom wall 6aa, and is being fixed to the light source mount block 6c. The reference numeral 28 in FIG. 4 denotes a plurality of positioning slots formed in the frame 22. By carrying out concavo-convex engaging of clutch of the positioning slot 28 to the rib 6f, the first reflector 21 is positioned to the light source mount block 6c and the light source 11.

In FIG. 1, angle θ1 represents the light shielding angle of the light source 11. The light shielding angle θ1 is prescribed by the straight line which passes through LED 13 allocated at the installation hole 24 of the segmental reflector 23, and the crest 25 of the segmental reflector 23 of the first reflector 21, and has pointed out more correctly the angle inserted at the straight line and ceiling 2. Even if the down-light 1 is looked up within the angle range, the LED 13 fails to be visually recognized.

The second reflector 31 functions as second luminous intensity distribution control member that controls the luminous intensity distribution of the light emitted from the LED 13, and is an one cast of the molding material of the first reflector 21, and a white synthetic resin of the same kind. As shown in FIG. 1, an upper end and a lower end are, the frames, for example, the annular frame, by which the opening is carried out, respectively, and the upper end opening of the second reflector 31 is smaller than a bottom opening. In other words, the inside diameter of the second reflector 31 is gradually molded greatly as it goes to a bottom opening from an upper end opening. The inner surface 31a which makes the reflective surface of the second reflector 31 is formed, for example on a part of curved surface. The inner surface 31a may be a straight slope.

The second reflector 31 has the annular flange 32 protruded outward at the bottom. From the ceiling recess 3 of the ceiling 2, the annular flange 32 is a diameter of a large, is in the state where the down-light 1 embedded on the ceiling 2 and is installed, and is caught in the circumference of the ceiling recess 3 from a lower part.

The second reflector 31 is allocated at the first reflector 21 bottom, and is connected with the bottom opening of the housing 5 with the fastening screw 32 screwed in through each fastening portion 6e of the above-mentioned housing principal member 6. The one fastening screw 32 is shown in FIG. 1. The inner surface 31a of the second reflector 31 connected with the housing 5 is continuing so that it may stand it in a row that it takes the same level with the inner surface (reflective surface) of the segmental reflector 23 of the first reflector 21. In other words, the inner surface 31a of the second reflector 31 and the inner surface (reflective surface) of the first reflector 21 are continuing so that the part by which the catoptric light from the first reflector 21, such as a level difference, fails to enter between the inner surface 31a of the second reflector 31 and the bottom inner surface of the segmental reflector 23 may fail to be formed. Thereby, shading does not yield in the inside 31a of the second reflector 3, and the whole area of the inner surface 31a shines brightly.

The light-transmissive insulation cover 35 is supported by the second reflector 31. The transparent cover plate 35 can also close and provide the undersurface opening of the second reflector 31. In the above embodiment, the upper end opening of the second reflector 31 is closed, and the transparent cover plate 35 is allocated. As compared with the case where the transparent cover plate 35 is formed in the undersurface opening of the second reflector 31, the small transparent cover plate 35 can be adopted by the, and the cost can be reduced.

The periphery of the transparent cover plate 35 is supported by being fit into the annular stepped recess 31b which followed the upper end opening and is formed in the edge of the upper end opening of the second reflector 31, and is supported. The periphery of the transparent, cover plate 35 is sandwiched between the bottom opening surface of the housing 5 and the bottom of the annular stepped recess 31b by that the second reflector 31 is fixed to the housing 5. The transparent cover plate 35 consisted of a clear glass board, a transparent acrylic resin board, etc., for example, and has insulated the light source 11 electrically to the lower part. It is also possible to replace with a transparent plate and to employ the resin board of diffusion permeability for the transparent cover plate 35, or it is also possible to utilize a transparent plate and a diffuse transmission plate in piles.

In FIG. 1, θ2 denotes the light shielding angle of the first reflector 21. In the bottom, the reflective surface which consists of an inner surface of the segmental reflector 23 is wholly specified to the light shielding angle θ2 as the bright surface at the case in the bottom opening of the bright surface, and the straight line which in other words passes through the bottom opening of the first reflector 21, and the edge of the bottom opening of the second reflector 31, and it has pointed out more correctly the angle inserted at the straight line and ceiling 2. Even if it looks up at the down-light 1 in the angle range, the reflective surface of the first reflector 21 fails to be visually recognized. And height H of the second reflector 31 is prescribed that the light shielding angle θ2 becomes smaller than the light shielding angle θ1 of the light source 11.

Although not illustrated on the external surface of the second reflector 31, it separates 180 degrees and a pair of spring mount portions is formed.

It attaches to each of these spring mount portion, and the bottom opening of the spring 41 is mounted. Thereby, a pair of mounting springs 41 allocated corresponding to the radial direction of the second reflector 31 are movable covering the first position aslant allocated to the housing 5, and the second position allocated so that the lateral surface of the housing 5 may be met.

The down-light 1 is installed in the ceiling 2 by elastically deforming a pair of mounting springs 41, and then inserting into the recess 3 on the ceiling 2 to the position that the annular flange 32 hustles against the ceiling 2. In the case, the down-light 1 follows on being pushed up, and it opens so that a pair of attachment springs 41 may become slanting gradually towards the first position. As a result, the perfect diffuse reflection and the annular flange 32 of these attachment spring 41 embed, the edge of the hole 3 is sandwiched, and the embedding state of the down-light 1 is maintained.

Lighting to the lower part by the down-light 1 is performed among the lights which LED 13 emitted from the light on which it is emitted downward, the light on which it is reflected in by each segmental reflector 23 of the first reflector 21, and is emitted downward, and the light on which it is reflected in by the second reflector 31, and is emitted downward, without reflection.

The light emitted from LED 13 enters into the whole area of the inner surface (reflective surface) of the segmental reflector 23 in the lighting. For the reason, since it reflects by carrying out complete diffuser of the incidence light by the whole area of the inner surface of each segmental reflector 23, the whole reflective surface of the first reflector 21 shines, as [symbol] also emitted light. By the way, the first reflector 21 is a light reflector which has a prism object or not a lens system but the lower end opening formed more greatly than these. Since it can consider that the inner surface of the first reflector 21 that carries out the complete diffuser reflection is a light-emitting surface, a large light-emitting surface can be assured. Therefore, it is easy to take out the optical power of LED 13 by reflection by each segmental reflector 23 of the first reflector 21.

The light which enters into the second reflector 31 among the lights reflected by the first reflector 21 enters into the whole inside 31a of the second reflector 31. As a result, as the inside 31a of the second reflector 31 also carries out complete diffuser of the incidence light, and is reflected and [symbol] also emitted light, it shines like an illumination. Further, the second reflector 31 is allocated at the first reflector 21 bottom so that the inner surfaces of each segmental reflector 23 take a same level with each other without making a level difference with the inside 31a of the second reflector 31. It is avoided that a portion into which the light reflected by the first reflector 21 fails to easily enter by that is formed in the second reflector 31, and it is controlled that a shadow is made into the portion which the first reflector 21 and second reflector 31 follow.

Therefore, in spite of that the first reflector 21 and the second reflector 31 are split vertically, the vertically joining inner surfaces 21a and 31a of the first and second reflectors 21 and 31 can be brightened wholly coherent.

The down-light 1 controls luminous intensity distribution of the light which LED 13 emitted like previous statement by the first reflector 21. For the reason, as compared with the case where controlling of the luminous intensity distribution is borne by the lens system with total reflection surface, the first reflector 21 is easy to be manufactured. Especially, in the above embodiment of the lens system wherein the first reflector 21 is molded by the white synthetic resin, manufacture is easier. Therefore, upon reduction of the manufacturing cost of the first reflector 21, the cost cut of the down-light 1 is possible.

In the down-light, 1, a plurality of segmental reflectors 23 wherein the first reflector 21 is allocated beneath the light source 11 adjoin each other so as to establish downward crest 25. Accordingly, when the first reflector 21 is looked up from lower level, as shown in FIG. 3, each crest 25 is so seen to be divided into each segmental reflector 23. These crests 25 are allocated beneath the installation hole 24 which these crests 25 provided in the top of the segmental reflector 23 by which LED 13 of the light source 11 is allocated, and the installation hole 24 is formed between the crests 25 which adjoined. Therefore, a part of light which LED 13 emitted can be interrupted by each crest 25 and the frame 22.

In other words, since the LED 13 is provided in the position of the slanting upper part which extended far back to the crest 25 allocated so that the adjoining segmental reflector 23 might be divided, the light shielding angle θ1 of the light source 11 specified by the straight line which passes through LED 13 and the crest 25 is ensured. Therefore, the dazzle feeling of high-intensity LED 13 which the light source 11 had can be mitigated according to the light shielding angle θ1.

By the way, since the luminosity of the inner surface of each segmental reflector 23 goes up rather than a case of specular reflection since the inner surface effect the perfect diffuse reflection as above-mentioned. In other words, the luminosity of the inside of the first reflector 21 it can be considered that is a bright surface goes up. On the other hand, the second reflector 31 is allocated beneath the first reflector 21 in succession. Thereby, the light shielding angle θ2 of the first reflector 21 specified by the straight line passing through the edge of the bottom opening of the second reflector 31 and the bottom opening of the first reflector 21 is secured. As a result, the glare of the first reflector 21 is mitigated by the light shielding angle θ2.

In the composition which bores reflection by two of upper and lower sides of the first reflector 21 and the second reflector 31, the light shielding angle θ2 of the first reflector 21 is made smaller than the light shielding angle θ1 of a light source like previous statement. As a result, it is not necessary to make the light shielding angle θ2 of the first reflector 21 into the same angle as the light shielding angle θ1 of a light source. Therefore, as compared with the case where the light shielding angle θ1 is secured, height H of the second reflector 31 can be made low in the second reflector 31. Since the illuminated zone obtained by reflection in the lower part in the second reflector 31 is not narrowed by the, the optical performance of the down-light 1 does not fall.

With the, since height H of the second reflector 31 becomes low, the height of the down-light 1 with the second reflector 31 becomes low at the first reflector 21 bottom, and the embedding depth to the space under the roof can be made shallow.

In the lighting apparatus according to the first aspect of the present invention, it becomes small gradually as a plurality of segmental reflectors of the first reflector allocated at the light source bottom go to the upper top opening. A semiconductor light emitting device is allocated at the installation hole. In addition, since it is not necessary to secure the same light shielding angle as the light shielding angle of the light source specified by the straight line which passes through a semiconductor light emitting device and the bottom edge of first reflector by the second reflector, the height of the second reflector can be made low. Therefore, the dazzle feeling of high-intensity LED 13 which the light source 11 had can be mitigated according to the light shielding angle θ1. Since the height of the second reflector is defined to secure that a first light shielding angle specified by a straight line passing through the semiconductor light emitting device and the bottom edge of the segmental reflector of the first reflector is larger than a second light shielding angle specified by a straight line passing through the bottom edge of the segmental reflector of the first reflector and the bottom edge of the second reflector, the glare of the light source is able to be mitigated.

In the lighting apparatus according to the second aspect of the present invention, since a plurality of segmental reflectors which the reflector allocated at the light source bottom has form a downward crest and adjoin while they are mutual, when the first reflector is looked up at from a lower part, each crest is provided so that each segmental reflector may be divided. And it is allocated in the installation hole in which these crests provided in the top of the segmental reflector by which the semiconductor light emitting device of a light source is allocated, and the installation hole is provided between the crests which adjoined. In other words, the semiconductor light emitting device is provided in the position of the slanting upper part which extended far back to the crest allocated so that the adjoining segmental reflector might be divided. Thereby, a part of light emitted from the semiconductor light emitting device of the light source is interrupted by the crest of the first reflector for controlling the luminous intensity distribution. Since the light shielding angle over a light source, i.e., the light shielding angle specified by the straight line which passes through a semiconductor light emitting device and a crest of the segmental reflector of the first reflector, is ensured by the first reflector, the dazzle feeling of a light source can be mitigated according to the light shielding angle.

In the lighting apparatus according to the second aspect of the present invention, while being able to secure the light shielding angle of a light source by the member which controls luminous intensity distribution of the light which the semiconductor light emitting device emitted and being able to reduce a dazzle feeling, the lighting apparatus whose cost can be cut down can be provided.

In the lighting apparatus according to the third aspect of the present invention, since it is not necessary to secure the same light shielding angle as the light shielding angle of the light source specified by the straight line which passes through a semiconductor light emitting device and the crest of the segmental reflector of the first reflector by the second reflector, the height of the second reflector can be made low. Thereby, while being able to lower the height of a lighting apparatus with the second reflector at the first reflector bottom, it can control that the illuminated zone obtained by reflection by the second reflector is narrowed.

Further to the second aspect of the lighting apparatus, in the lighting apparatus according to the third aspect of the present invention, while being able to lower the height of a lighting apparatus with the second reflector at the first reflector bottom, it can control that the illuminated zone obtained by reflection by the second reflector is narrowed.

In the lighting apparatus according to the fourth aspect of the present invention, the semiconductor light emitting device which is a live part can be electrically insulated from that lower part with a transparent cover plate. Since a transparent cover plate closes an upper end opening smaller than the bottom opening of the second reflector and is provided, it is small made as compared with the case where to closed the bottom opening of the second reflector and a transparent cover plate is provided, and, so, can employ the transparent cover plate of low cost.

Further to the third aspect of the lighting apparatus, in the lighting apparatus according to the fourth aspect of the present invention, a semiconductor light emitting device can be electrically insulated from the lower part with a small transparent cover plate.

What is claimed is:

1. A lighting apparatus, comprising:
a housing;
a first reflector, which is mounted beneath the light source and formed in a convex body gradually thinning down toward upward, comprising a plurality of segmental reflectors having on its top a installation hole for arranging the semiconductor light emitting device and on its bottom opened wider than the installation hole; and
a second reflector allocated beneath the first reflector,
wherein the height of the second reflector is defined to secure that a first light shielding angle specified by a straight line passing through—the semiconductor light emitting device and the bottom edge of the segmental reflector of the first reflector is larger than a second light shielding angle specified by a straight line passing through the bottom edge of the segmental reflector of the first reflector and the bottom edge of the second reflector.

2. A lighting apparatus, comprising:
a housing;
a light source comprising a plurality of semiconductor light emitting devices, and allocated in the housing so as that the semiconductor light emitting devices are directed downward; and
a first reflector, which is mounted beneath the light source and formed in a convex body gradually thinning down toward upward, comprising a plurality of segmental reflectors having on its top a installation hole for arranging the semiconductor light emitting device and on its bottom opened wider than the installation hole; and
wherein adjacent segmental reflectors form a downward crest beneath the installation hole, and the installation hole is allocated between adjacent crests at an obliquely upward recess from the crest.

3. A lighting apparatus as claimed in claim 2, further comprises:
a second reflector having openings at its top and bottom,
wherein the second reflector is allocated beneath the first reflector so as that the open top of the second reflector is connected to the bottom edge of the first reflector, and
wherein the height of the second reflector is defined to secure that a first light shielding angle specified by a straight line passing through—the semiconductor light emitting device and the crest of the segmental reflector of the first reflector is larger than a second light shielding angle specified by a straight line passing through the bottom edge of the segmental reflector of the first reflector and the bottom edge of the second reflector.

4. A lighting apparatus as claimed in claim 3, further comprises:
a light-transmissive insulation cover for covering the bottom edge of first reflector,
wherein the second reflector is made its top opening smaller than its bottom opening, and
the light-transmissive insulation cover is allocated on the top of the second reflector so as that the top opening of the second reflector.
